(19) United States
(12) Patent Application Publication
(10) Pub. No.: US 2002/0028702 A1
(43) Pub. Date: Mar. 7, 2002

(54) Method and apparatus for transmitting and receiving data using continuous tone control squelch system

(76) Inventor: Jong-Oh Kim, Kyungki-do (KR)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 09/838,675

(22) Filed: Apr. 19, 2001

(30) Foreign Application Priority Data
Apr. 19, 2000 (KR) 2000-20673

(51) Int. Cl. H04B 7/00

(52) U.S. Cl. 455/701; 455/219; 455/218; 455/456

(57) ABSTRACT

A method and apparatus for transmitting and receiving data using a continuous tone control squelch system (CTCSS), which can transmit and receive data simultaneously with voice communication using the CTCSS. The apparatus is capable of transmitting and receiving a global positioning system (GPS) data signal containing a position value together with a voice signal using the CTCSS by a wireless communication terminal. Therefore, a user of the terminal can notify another party of his or her current position while conducting a voice conversation therewith. The method comprises dividing an effective frequency band of the CTCSS into regular intervals, setting the divided intervals as channels and assigning data code values respectively to the set channels. For data transmission, CTCSS frequency signals corresponding respectively to code values of specific data are successively transmitted. For data reception, successively received CTCSS frequency signals are converted into corresponding data code values, respectively. In this manner, data can be transmitted and received together with a voice signal.

### BACKGROUND OF THE INVENTION

1. Field of the Invention

The present invention relates in general to data transmission/reception method and apparatus for a wireless communication terminal, and more particularly to a method and apparatus for transmitting and receiving data using a continuous tone control squelch system (CTCSS), which can transmit and receive data simultaneously with voice communication using the CTCSS.

2. Description of the Prior Art

For wireless data communication, digital data, which is expressed in only two state values, ‘0’ and ‘1’, must be converted into an analog signal in an appropriate manner and then transmitted and received. As well-known in the art, the representative examples of modulation methods for data communication may be a frequency shift keying (FSK) and minimum shift keying (MSK).

However, modulation methods for data communication known up to now, including the above methods, convert digital data into a frequency signal of a voice grade according to its state and transmit the converted frequency signal. In this regard, conventional data communication systems have a disadvantage in that they cannot perform voice communication and data communication at the same time.

### SUMMARY OF THE INVENTION

Therefore, the present invention has been made in view of the above problem, and it is an object of the present invention to provide a method and apparatus for transmitting and receiving data using a continuous tone control squelch system (CTCSS), which can transmit and receive data simultaneously with voice communication using the CTCSS.

It is another object of the present invention to provide a method and apparatus for transmitting and receiving data using a CTCSS, which can transmit and receive a global positioning system (GPS) data signal together with a voice signal using the CTCSS by a wireless communication terminal, so that a user of the terminal can notify another party of his or her current position while conducting a voice conversation therewith.

In accordance with one aspect of the present invention, the above and other objects can be accomplished by the provision of a method for transmitting and receiving data using a continuous tone control squelch system (CTCSS), comprising the steps of a) dividing an effective frequency band of the CTCSS into regular intervals, setting the divided intervals as channels and assigning data code values respectively to the set channels; b) for data transmission, successively transmitting CTCSS frequency signals corresponding respectively to code values of specific data; and c) for data reception, converting successively received CTCSS frequency signals into corresponding data code values, respectively.

In accordance with another aspect of the present invention, there is provided an apparatus for transmitting and receiving data using a continuous tone control squelch system (CTCSS) by a first wireless communication terminal one-to-one communicating with a second wireless communication terminal, the first and second wireless communication terminals being the same in construction, the apparatus comprising transmitter means including a first data processor for converting specific data to be transmitted into CTCSS frequency signals on the basis of a pre-registered CTCSS frequencies-by-codes table, a CTCSS frequency generator for generating the converted CTCSS frequency signals under control of the first data processor, and a radio transmitter for mixing the CTCSS frequency signals from the CTCSS frequency generator with a voice signal from the first wireless communication terminal and transmitting the mixed result to the second wireless communication terminal over a predetermined carrier; and receiver means including a radio receiver for receiving a carrier signal containing CTCSS frequency signals and a voice signal from the second wireless communication terminal and separating the CTCSS frequency signals and voice signal from the received carrier signal, a CTCSS frequency discriminator for discriminating which frequencies of the pre-registered CTCSS frequencies-by-codes table are channel frequencies of the CTCSS frequency signals separated by the radio receiver, and a second data processor for converting the CTCSS frequency signals separated by the radio receiver into the original data on the basis of the pre-registered CTCSS frequencies-by-codes table and the results discriminated by the CTCSS frequency discriminator.

Preferably, the transmitter means may further include a first global positioning system (GPS) set for receiving GPS data, calculating a position value of the first wireless communication terminal on the basis of the received GPS data and outputting the calculated position value as the specific data to be transmitted, to the first data processor; and the receiver means may further include a second GPS set for processing the data converted by the second data processor to output information regarding the position of the second wireless communication terminal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram of an apparatus for transmitting and receiving global positioning system (GPS) data using a continuous tone control squelch system (CTCSS) in accordance with the present invention.

### DETAILED DESCRIPTION OF THE PREFERRED EMBODIMENTS

As well known in the art, a frequency band used to transfer a signal of human voice is 300 Hz˜3 KHz. In this connection, in order to transmit and receive data simultaneously with voice communication, the data must be converted into a signal of a frequency band other than the above voice band (300 Hz˜3 KHz). Therefore, the principle of the present invention is to transmit and receive data at a frequency of a continuous tone control squelch system (CTCSS) which employs a frequency band lower than the above voice band (300 Hz˜3 KHz).

The CTCSS has been proposed to suppress noise components occurring when no signal is present in an audio system. This CTCSS employs a signal of a frequency band lower than the voice band as a control signal to check whether there is a frequency signal set to be lower than the voice band and control audio equipment in accordance with the checked result.

This inventor intends to utilize for data transfer the CTCSS usually used for noise suppression and equipment control. To this end, the inventor divides an effective frequency band of the CTCSS into regular intervals and sets the divided intervals as channels.

In other words, because the effective frequency band of the CTCSS is 67 Hz˜250 Hz, it may be divided into a plurality of channels at an interval of, for example, 10 Hz. Then, a specific code is assigned to a center frequency of each of the divided channels.

The below table 1 shows examples of 3-bit code values assigned respectively to CTCSS frequencies.

TABLE 1

| | 3-BIT CODE | CTCSS FREQUENCY |
|---|---|---|
| 0 | 000 | 88.5 Hz |
| 1 | 001 | 94.8 Hz |
| 2 | 010 | 100.0 Hz |
| 3 | 011 | 107.2 Hz |
| 4 | 100 | 114.8 Hz |
| 5 | 101 | 123.0 Hz |
| 6 | 110 | 131.8 Hz |
| 7 | 111 | 141.3 Hz |

Data is converted into CTCSS frequency signals on the basis of the CTCSS frequencies-by-codes table set as in the above, and then transmitted.

For example, for transmission of data “101010011”, a frequency of 123.0 Hz is first generated corresponding to ‘101’ for a predetermined period of time. Thereafter, a frequency of 100.0 Hz is generated corresponding to the next code value ‘010’ and a frequency of 107.2 Hz is in turn generated corresponding to the subsequent code value ‘011’.

In this case, a receiver successively receives the CTCSS frequency signals of 123.0 Hz, 100.0 Hz and 107.2 Hz and then discriminates them with reference to the CTCSS frequencies-by-codes table set as in the above. As a result of the discrimination, the receiver recognizes the CTCSS frequency signal of 123.0 Hz as the code ‘101’, the CTCSS frequency signal of 100.0 Hz as the code ‘010’ and the CTCSS frequency signal of 107.2 Hz as the code ‘011’, respectively, and ultimately receives the data “101010011”.

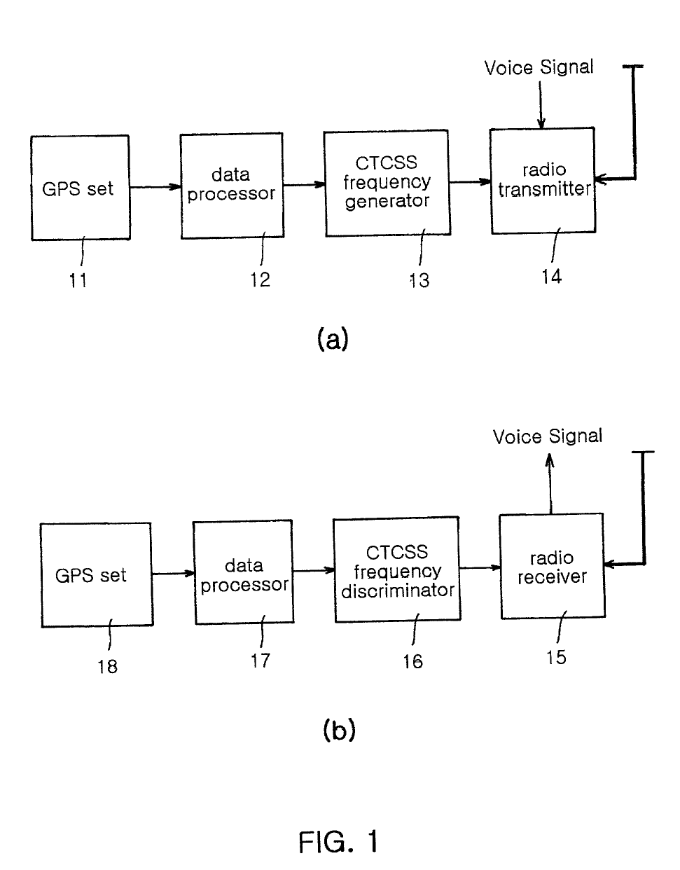

Another object of this invention is to, between wireless communication terminals one-to-one communicating with each other, transfer specific data, such as global positioning system (GPS) data indicative of the position of each terminal, simultaneously with voice communication, not via a switching center. FIG. 1 shows the construction of a CTCSS-based data transmission/reception apparatus for a wireless communication terminal in accordance with the present invention.

That is, FIG. 1 shows the construction of a CTCSS-based data transmission/reception apparatus for a wireless communication terminal which is capable of transmitting and receiving GPS data together with a voice signal using the CTCSS in accordance with the present invention, wherein FIG. 1A is a block diagram of a transmitter module and FIG. 1B is a block diagram of a receiver module.

With reference to FIG. 1, the data transmission/reception apparatus employing the CTCSS in accordance with the present invention comprises a transmitter module (FIG. 1A) including a first GPS set 11 for receiving a GPS satellite signal, calculating a position value of the wireless communication terminal on the basis of the received GPS satellite signal and displaying the calculated position value. The transmitter module further includes a first data processor 12 for converting the position value calculated by the first GPS set 11 into CTCSS frequency signals on the basis of a pre-registered CTCSS frequencies-by-codes table, a CTCSS frequency generator 13 for generating the converted CTCSS frequency signals under control of the first data processor 12, and a radio transmitter 14 for transmitting the CTCSS frequency signals from the CTCSS frequency generator 13 over a carrier together with a voice signal from a user of the wireless communication terminal. The data transmission/reception apparatus further comprises a receiver module (FIG. 1B) including a radio receiver 15 for receiving a carrier signal containing a voice signal and CTCSS frequency signals from another wireless communication terminal and separating the voice signal and CTCSS frequency signals containing data information from the received carrier signal. The receiver module further includes a CTCSS frequency discriminator 16 for discriminating which frequencies of the pre-registered CTCSS frequencies-by-codes table are channel frequencies of the CTCSS frequency signals separated by the radio receiver 15, a second data processor 17 for converting the CTCSS frequency signals separated by the radio receiver 15 into the original data on the basis of the results discriminated by the CTCSS frequency discriminator 16 and the pre-registered CTCSS frequencies-by-codes table, and a second GPS set 18 for processing output data from the second data processor 17 and displaying the position of another wireless communication terminal in accordance with the processed result.

As an alternative, the first data processor 12 in the transmitter and the second data processor 17 in the receiver may be integrated into a single unit. In this case, a single data processor is implemented to process both the conversion of data to be transmitted into CTCSS frequency signals and the conversion of received CTCSS frequency signals into data.

Further, the first GPS set 11 in the transmitter and the second GPS set 18 in the receiver may be integrated into a single unit.

The global positioning system (GPS) is a position measurement system using a GPS satellite covering all areas on the earth, which is typically called a wide-area positioning system, global positioning system or satellite navigation system. This system basically comprises a plurality of GPS satellites for successively transmitting navigation messages necessary to position calculation to a user over a carrier, a plurality of satellite control stations for tracking and monitoring the GPS satellites and conducting a variety of corrections thereof, and a GPS set carried by the user. The GPS set is provided with a GPS receiver for receiving a GPS satellite signal and calculating the user's position from the received signal, and application devices associated with the GPS receiver. Each of the GPS satellites transmits a positioning signal containing a P (precision or protect) code, which is a high-precision signal, and a C/A (clear and acquisition or coarse and access) code, which is a low-precision signal. Of these signals, the C/A code is received and used by a general person.

In this regard, each of the first and second GPS sets 11 and 18 shown in FIG. 1 includes a hardware module composed of an antenna and receiver for receiving a signal transmitted from a GPS satellite, and a signal processor for processing the received signal. Each of the first and second GPS sets 11 and 18 also includes a software module composed of a data processing program for processing GPS data, a satellite signal tracking program for tracking receivable GPS satellite signals around the receiver, and a navigation algorithm for measuring a time period for signal propagation from the satellite to the receiver on the basis of received satellite information and calculating the position and speed of the receiver from the measured time period. This construction of the GPS set is well known in the art and a detailed description thereof will thus be omitted.

A detailed description will hereinafter be given of the operation of the CTCSS-based data transmission/reception apparatus with the above-stated construction in accordance with the present invention.

First, the first GPS set 11 receives a GPS satellite signal and calculates a current position value of an associated wireless communication terminal on the basis of the received GPS satellite signal. The first GPS set 11 then indicates the calculated position value and outputs GPS information containing the calculated position value to the first data processor 12.

The first data processor 12 controls the CTCSS frequency generator 13 on the basis of a pre-registered CTCSS frequencies-by-codes table to successively generate CTCSS frequencies by codes corresponding to input GPS data. As a result, the CTCSS frequency generator 13 is operated under the control of the first data processor 12 to successively generate CTCSS frequencies by codes corresponding to GPS data to be transmitted. Then, the CTCSS frequency generator 13 provides CTCSS frequency signals lower than the voice band to the radio transmitter 14. Thereafter, the radio transmitter 14 mixes the CTCSS frequency signals from the CTCSS frequency generator 13 with a voice signal from a user of the associated wireless communication terminal and transmits the mixed result over a predetermined carrier via an antenna.

Thereafter, the radio receiver 15 receives a carrier signal containing a voice signal and CTCSS frequency signals, transmitted from another wireless communication terminal, and separates the voice signal and CTCSS frequency signals from the received carrier signal.

The separated voice signal from the radio receiver 15 is inputted to a voice signal processor (not shown) in the wireless communication terminal of the user, which then converts the inputted voice signal into an audio signal audible by the user. The separated CTCSS frequency signals from the radio receiver 15 are inputted to the CTCSS frequency discriminator 16, which then discriminates which frequencies of the pre-registered CTCSS frequencies-by-codes table are channel frequencies of the inputted CTCSS frequency signals.

The CTCSS frequency discriminator 16 provides the discriminated values to the second data processor 17, which then converts the CTCSS frequency signals separated by the radio receiver 15 into the original GPS data on the basis of the pre-registered CTCSS frequencies-by-codes table and the discriminated values and outputs the converted GPS data to the second GPS set 18. The second GPS set 18 processes the output GPS data from the second data processor 17 and outputs information, for example, position information, of another party in accordance with the processed result.

In this manner, the data transmission/reception apparatus can transmit and receive data together with a voice signal. Therefore, the user can exchange desired information with another party without stopping a voice conversation therewith.

As apparent from the above description, the present invention provides a method and apparatus for transmitting and receiving data using a continuous tone control squelch system (CTCSS), which can transmit and receive data simultaneously with voice communication using the CTCSS. Therefore, for communication via wireless communication terminals, a user can receive data, such as GPS information and position, time and speed information, from another party while conducting a voice conversation therewith.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for transmitting and receiving data using a continuous tone control squelch system (CTCSS), comprising the steps of:
a) dividing an effective frequency band of said CTCSS into regular intervals, setting the divided intervals as channels and assigning data code values respectively to the set channels;
b) for data transmission, successively transmitting CTCSS frequency signals corresponding respectively to code values of specific data; and
c) for data reception, converting successively received CTCSS frequency signals into corresponding data code values, respectively.

2. The method as set forth in claim 1, wherein said effective frequency band of said CTCSS is 67 Hz˜250 Hz.

3. The method as set forth in claim 1, wherein said step b) includes the step of transmitting said CTCSS frequency signals corresponding respectively to said code values of said specific data together with a user's voice signal over a carrier; and wherein said step c) includes the step of receiving a carrier signal containing a voice signal and CTCSS frequency signals from another party, separating the voice signal and CTCSS frequency signals from the received carrier signal, performing an audio signal processing operation for the separated voice signal and converting the separated CTCSS frequency signals into corresponding data code values, respectively; whereby the data transmission and data reception are conducted without stopping a voice conversation.

4. The method as set forth in claim 1, wherein said data transmitted and received using said CTCSS frequency signals is global positioning system (GPS) data.

5. The method as set forth in claim 1, wherein said step a) includes the step of, if the number of code bits is n, dividing said effective frequency band of said CTCSS into 2ⁿ channels and assigning data code values respectively to center frequencies of the divided channels.

6. An apparatus for transmitting and receiving data using a continuous tone control squelch system (CTCSS) by a first wireless communication terminal one-to-one communicating with a second wireless communication terminal, said first and second wireless communication terminals being the same in construction, said apparatus comprising:
transmitter means including a first data processor for converting specific data to be transmitted into CTCSS frequency signals on the basis of a pre-registered CTCSS frequencies-by-codes table, a CTCSS frequency generator for generating the converted CTCSS frequency signals under control of said first data processor, and a radio transmitter for mixing said CTCSS frequency signals from said CTCSS frequency generator with a voice signal from said first wireless communication terminal and transmitting the mixed result to said second wireless communication terminal over a predetermined carrier; and
receiver means including a radio receiver for receiving a carrier signal containing CTCSS frequency signals and a voice signal from said second wireless communication terminal and separating the CTCSS frequency signals and voice signal from the received carrier signal, a CTCSS frequency discriminator for discriminating which frequencies of said pre-registered CTCSS frequencies-by-codes table are channel frequencies of said CTCSS frequency signals separated by said radio receiver, and a second data processor for converting said CTCSS frequency signals separated by said radio receiver into the original data on the basis of the pre-registered CTCSS frequencies-by-codes table and the results discriminated by said CTCSS frequency discriminator.

7. The apparatus as set forth in claim 6, wherein said apparatus is installed in each of said first and second wireless communication terminals to transmit data about the position of one terminal to the other terminal simultaneously with voice communication.

8. The apparatus as set forth in claim 6, wherein said transmitter means further includes a first global positioning system (GPS) set for receiving GPS data, calculating a position value of said first wireless communication terminal on the basis of the received GPS data and outputting the calculated position value as said specific data to be transmitted, to said first data processor; and wherein said receiver means further includes a second GPS set for processing said data converted by said second data processor to output information regarding the position of said second wireless communication terminal; whereby said apparatus transmits GPS information of said first wireless communication terminal to said second wireless communication terminal together with said voice signal from said first wireless communication terminal, receives GPS information and said voice signal from said second wireless communication terminal and displays the position of said second wireless communication terminal on the basis of the received GPS information.

9. The apparatus as set forth in claim 8, wherein said first GPS set and second GPS set are integrated into a single GPS set, said single GPS set being adapted for receiving a GPS satellite signal, calculating the position value of said first wireless communication terminal on the basis of the received GPS satellite signal, outputting the calculated position value as said specific data to be transmitted, to said first data processor in said transmitter means, processing said data converted by said second data processor in said receiver means and displaying the position of said second wireless communication terminal in accordance with the processed result.
